(19) United States
(12) Patent Application Publication
(10) Pub. No.: US 2003/0010071 A1
(43) Pub. Date: Jan. 16, 2003

(54) Mind games (luggage anti-theft protection system)

(76) Inventor: James Jenkins, Orlando, FL (US)

Correspondence Address: JAMES JENKINS JR., 2760 E. COLONIAL DR. #119, Orlando, FL, 32803, US

(21) Appl. No.: 09/901,916

(22) Filed: Jul. 10, 2001

(51) Int. Cl. E05B 65/52

(52) U.S. Cl. 70/69

(57) ABSTRACT

This invention is designed to prevent luggage from being stolen from airports. It uses a number of various size coinciding threaded receptacles and threaded rods to prevent theft. Luggage secured with this system should only be handled by the owner who has the matching threaded rod. If a thief removes a piece of luggage from the conveyer he will have no idea what size rod he needs to match the receptacle. And it must be attached immediately. So anyone that removes luggage from conveyers or handles it without the correct key inserted onto the receptacle should be considered a suspected thief.

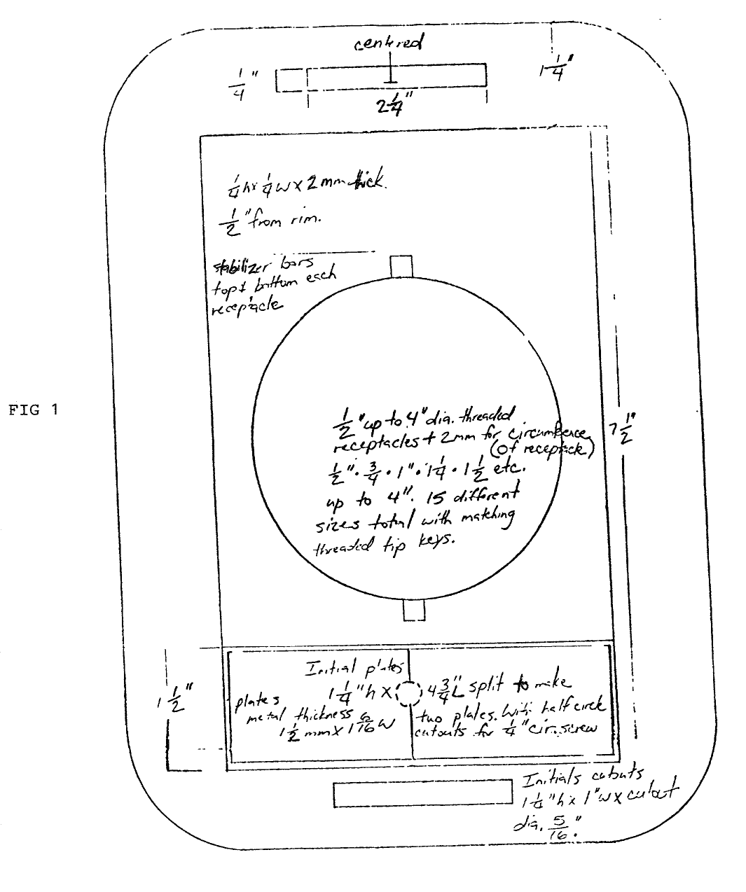

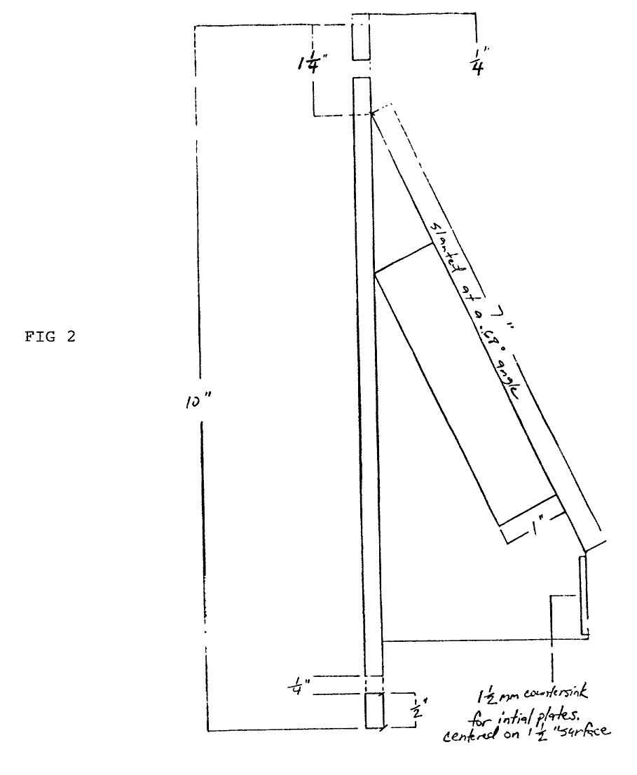

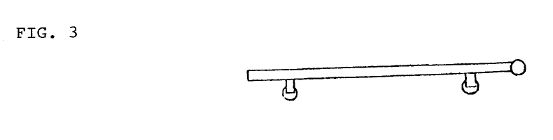

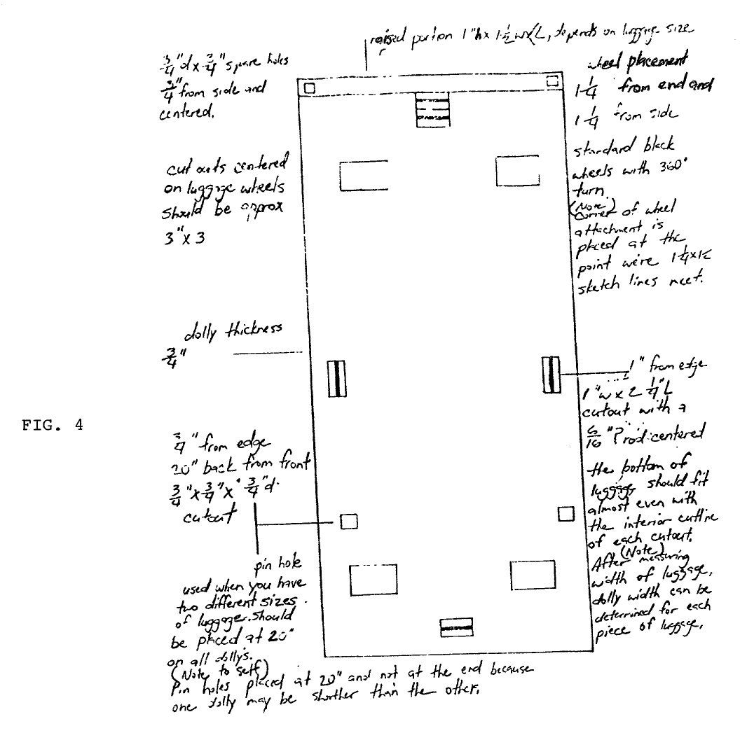

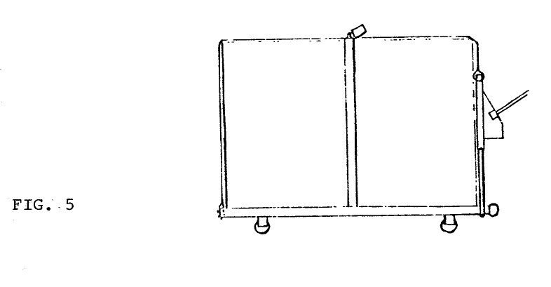

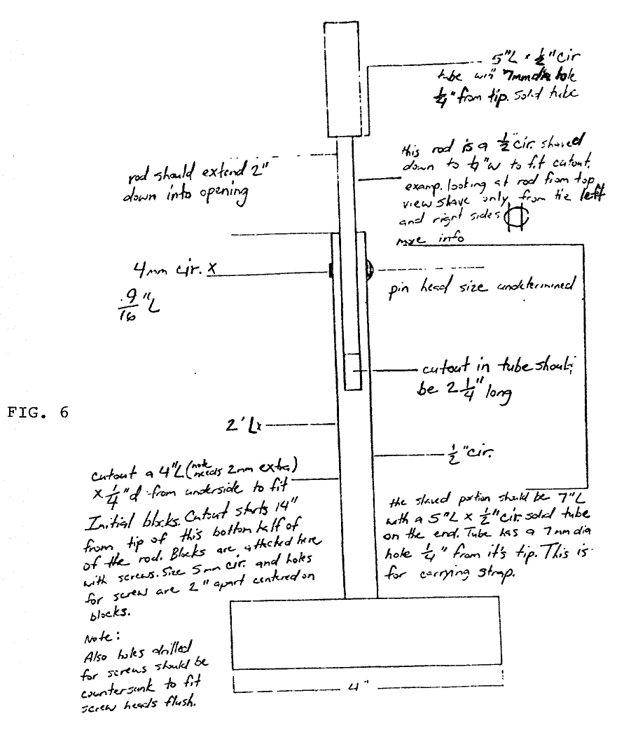

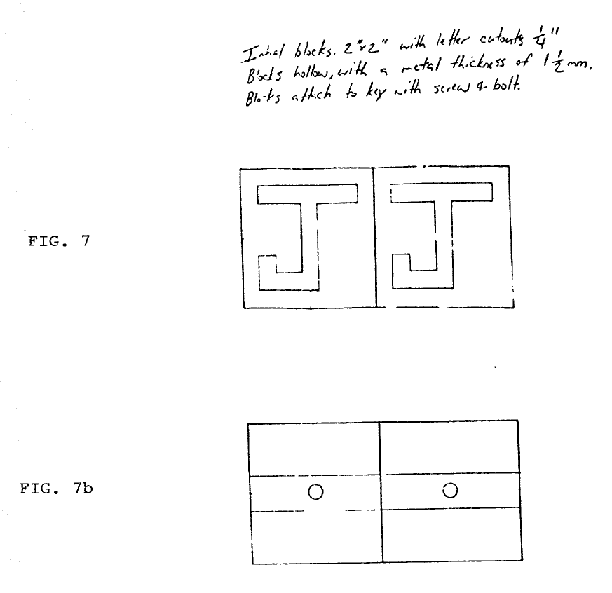

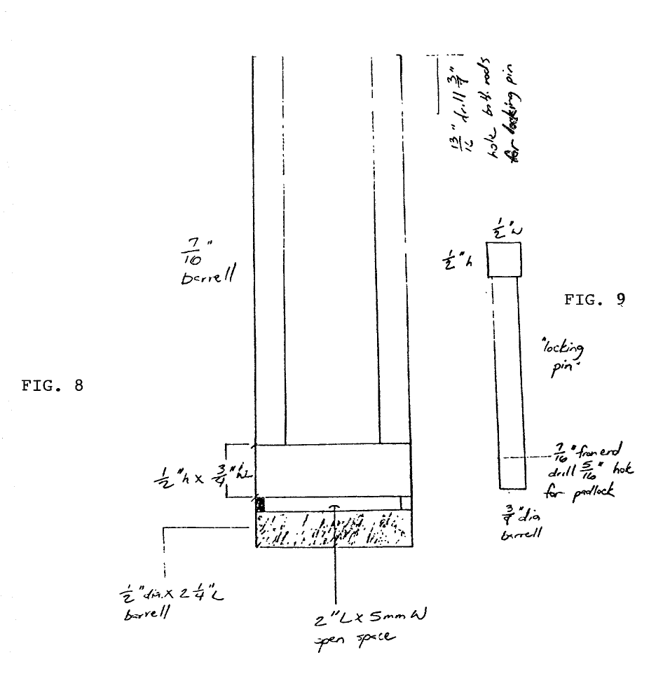

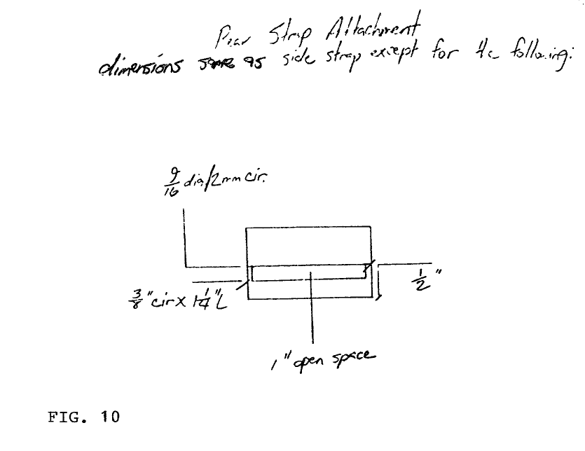

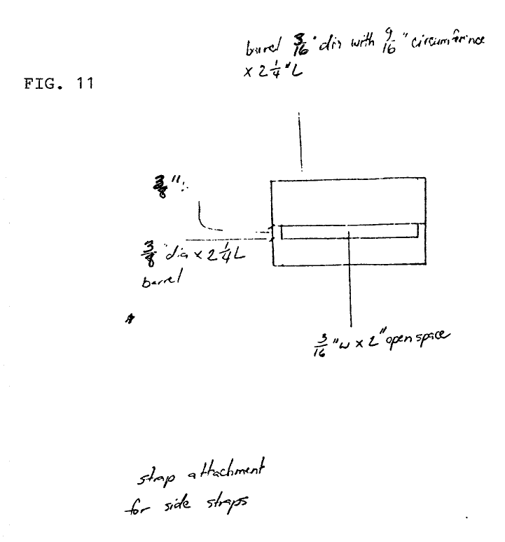

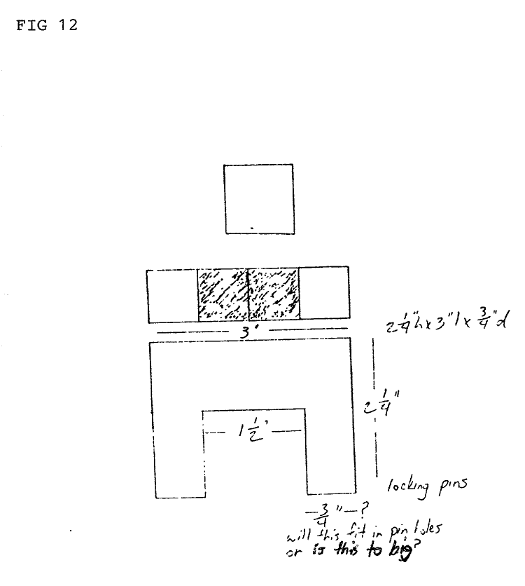

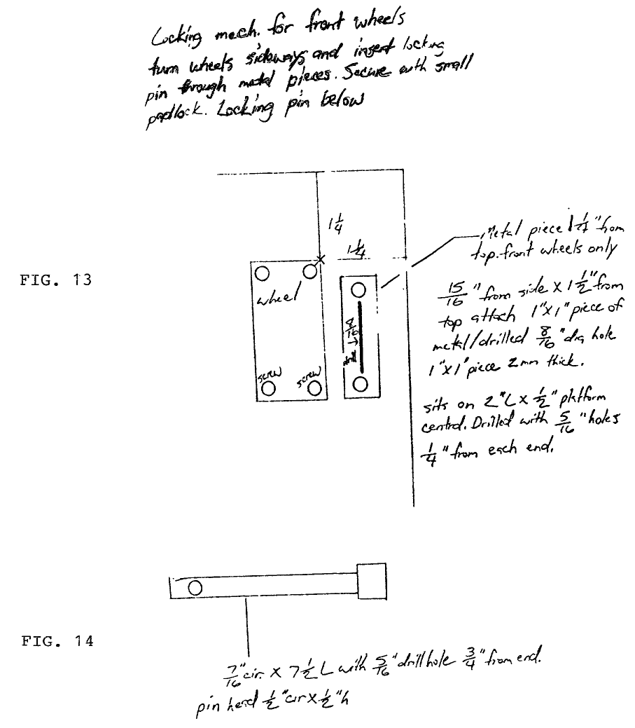

This invention is a device that can be used by travelers at airports to keep thier luggage from being stolen.

It consist primarily of three major parts, which are joined together by brightly colored nylon straps to form a anti-theft system. One part of this device is a triangular-shaped piece which is shown on pages 1-2, both front and side views. This piece fits at either end of the luggage and is centered. This piece is made of high density plastic. It has a threaded cyclinder shaped receptacle that comes in approximately fifteen different sizes along with matching threaded rods used as keys and a handle to pull the luggage with. This receptacle is made of a metal yet to be determined. The threaded rod screws into the receptacle on the triangular-shaped piece and should fit flush with the beveled surface as illustrated on page 5. Once the rod is attached the luggage can be pulled and this is the first indication that the person with the luggage is the owner. If someone removes luggage from the conveyer and cannot immediately produce the exact matching threaded rod, the will not be able to claim it and most importantly they will not be able to leave the airport. The second step taken to prevent theft is to attach two metal initial plates to the beveled portion of the triangular piece. These plates would have the owners initials cut-out. These initials must coincide with metal initial blocks that attach to the underside of the metal rod used to claim luggage with. These blocks would be hollow and painted on one side and the plates should be marked with a 1″ paint line placed on the outside edge. In order to maximize the effectiveness of this system, airport personnel should prohibit hand-carrying luggage with the exception of small handbags, briefcases, etc. The rods should be carried on board inside of a carrying case. Pages 3-4 are side and top views of the dolly on which the luggage will ride. Attached to dolly will be nylon straps that are joined together at the top of the luggage and are interlocked using a plastic fastener that would be secured with a small pin inserted into the fastener and the pin would be secured in place with a small padlock. And finally page 5 is a overall side view of how the invention looks when in use.

1. Used to claim luggage and keep it from being stolen from airport conveyers, the airport in general, or anywhere luggage is left unattended. This system can also be used to claim and protect any item of value from theft.

2. Used to show proof of ownership of luggage when checking out of airports. Travelers should insert the threaded tip rod into each receptacle so security can verify ownership at a glance instead of checking each baggage claim ticket. This allows for a much faster check out time and keeps security from having to match all those numbers together.

3. Used to transport luggage.
I claim the threaded tip rod and threaded receptacle as my invention. But the matching initial blocks and initial plates along with the color matching system are for added protection and are just as important. The rod tips and receptacles come in various sizes, therefore making it virtually impossible for anyone besides the owner to claim the luggage. A thief will have no ide idea what size rod he will need to claim a particular piece of luggage. The rod must be inserted into the receptacle as soon as the luggage is pulled from the conveyer. The rod is screwed into the receptacle and should the same as a metal nut and bolt when joined together.
